(19) United States
(12) Patent Application Publication
(10) Pub. No.: US 2025/0112964 A1
(43) Pub. Date: Apr. 3, 2025

(54) Computer-Implemented Method of Providing a Technical Assessment for Certification Of A Managed Cybersecurity Service Provider

(71) Applicant: SPECTRA Ltd., Hamilton (BM)

(72) Inventors: Edouard von Herberstein, Hamilton (BM); Eric Altamura, Hamilton (BM)

(21) Appl. No.: 18/888,964

(22) Filed: Sep. 18, 2024

Related U.S. Application Data
(60) Provisional application No. 63/586,505, filed on Sep. 29, 2023.

(51) Int. Cl. H04L 9/40

(52) U.S. Cl. CPC H04L 63/20; H04L 63/0823

(57) ABSTRACT

A computer-implemented method of evaluating for certification a managed cybersecurity service provider (hereinafter “MSP”) in providing a service in a field, the method being implemented with computer processes carried out by a certification agent server system, includes: receiving and storing general organizational and performance data of the MSP, such data being obtained from the MSP and a set of auditors; receiving and storing (i) organizational and performance data of the MSP in providing its service in the field, (ii) the MSP's architectural configuration data for providing its service in the field, (iii) the MSP's qualification data for providing its service in the field, (iv) financial data as to charges by the MSP for providing its service in the field, and (v) data characterizing cyber risk exposure of the MSP in providing its service in the field; processing the received data in relation to a set of benchmarks defining certifiable performance by the MSP in providing its service in the field to arrive at a determination if the MSP is providing its service in the field in a certifiable manner; and causing the determination to be supplied as an output.

### CROSS-REFERENCE TO RELATED APPLICATIONS

The present application claims priority to co-pending U.S. Provisional Patent Application Ser. No. 63/586,505 titled “Computer-Implemented Method of Evaluating for Certification A Managed Cybersecurity Service Provider”, filed on Sep. 29, 2023. The foregoing application is incorporated herein by reference in its entirety.

### TECHNICAL FIELD

The present invention relates to managed security service providers, and more particularly to a technical assessment of cyber-security performance for certifying a managed cybersecurity service provider, which may include certification of the technology, management team, and/or deployment solution for customers.

### BACKGROUND ART

Auditing, accounting, technology-specific certifying bodies or consortiums, and specific vendors offer certification of managed cybersecurity service providers for delivering services. However, these entities have been challenged to address risks comprehensively in the certification process. Most certifications provide either a vendor-agnostic approach, where the certification process is indifferent to the technologies used, or a vendor-specific approach, where the certification process is based on a specific vendor technology. In particular, many, if not all, certification methodologies fail to consider the interoperability of multiple vendor technologies used to deliver services in assessing cyber risk and disaster scenarios. Fewer still consider the insurability of the underlying service.

### SUMMARY OF THE EMBODIMENTS

In accordance with one embodiment of the invention, there is provided a computer-implemented method of providing a technical assessment for certification of a managed cybersecurity service provider (hereinafter “MSP”) in providing a cybersecurity service in a field. In this embodiment, the method is implemented with computer processes carried out by a certification agent server system. The computer processes of this embodiment include receiving and storing, by the certification agent server system, general organizational and performance data of the MSP, such data being obtained from the MSP and a set of auditors.

The computer processes further include receiving and storing, by the certification agent server system, (i) organizational and performance data of the MSP in providing its service in the field, (ii) the MSP's system architecture configuration data for providing its service in the field, (iii) the MSP's qualification data for providing its service in the field, (iv) financial data as to charges by the MSP for providing its service in the field, and (v) data characterizing cyber risk exposure of the MSP in providing its service in the field.

In a related embodiment, a data source of the received (i), (ii), (iii), (iv), and (v) is selected from the group consisting of: data of the MSP from audit sources; data from historical performance and success rate of service of the MSP; and data from scenario based cyber risk exposure.

The computer processes further include processing, by the certification agent server system, the received data in relation to a set of benchmarks defining technical performance by the MSP in providing its service in the field to arrive at a determination if the MSP is providing its service in the field in a reliable manner.

The computer processes further include causing, by the certification agent server system, the determination to be supplied as an output.

In a related embodiment, the field is selected from the group consisting of (i) backup as a service, (ii) disaster recovery as a service, (iii) firewall as a service, (iv) business email protection as a service, (v) managed endpoint security as a service and (vi) any other cybersecurity services.

In a further related embodiment, the computer-implemented method includes processing, by the certification agent server system, the received general organizational and performance data of the MSP to arrive at an initial determination of the MSP's ability to deliver services in an initial certifiable manner.

In another related embodiment, the general organizational and performance data, in a context of evaluating the MSP for certification, comprises data relating to a management and a performance in providing services that apply to the MSP as a whole.

In another related embodiment, the set of benchmarks comprises minimum requirements that apply to the service in the field, with which the MSP must comply.

In another related embodiment, the set of benchmarks comprises minimum requirements that apply to the service in the field with which the MSP must comply.

### BRIEF DESCRIPTION OF THE DRAWINGS

The foregoing features of embodiments will be more readily understood by reference to the following detailed description, taken with reference to the accompanying drawings, in which:

FIG. 1 is a block diagram of a computer system for providing a technical assessment of an MSP for certification in providing a cybersecurity service in a field in accordance with an embodiment of the present invention.

FIG. 2 is a block diagram illustrating a method for providing a technical assessment of an MSP 102 for certification in providing a cybersecurity service in a field.

FIG. 3 is a logical data flow of various general organizational and performance data of the MSP used to perform an initial certification.

FIG. 4 is a logical data flow of various data sources providing evidence used to determine whether the MSP meets the requirements for certification in providing a service in a field.

FIG. 5 illustrates a logical flow for the certification of an MSP in providing a service in a field.

### DETAILED DESCRIPTION OF SPECIFIC EMBODIMENTS

Definitions. As used in this description and the accompanying claims, the following terms shall have the meanings indicated, unless the context otherwise requires:

A “set” includes at least one member.

An “MSP” is a managed cybersecurity service provider.

A “CASS” is a certified agent server system.

A service “in a field” is a managed information technology (IT) service of a specific type, provided by an MSP. A service in a field may be selected from the group consisting of (i) backup as a service, (ii) disaster recovery as a service, (iii) firewall as a service, (iv) business email protection as a service, (v) managed endpoint security as a service and (vi) any other cybersecurity services.

The “general organizational and performance data of the MSP”, in the context of a process of certifying a MSP, are data relating to the management and performance in providing services that apply to the MSP as a whole.

An MSP's “organizational and performance data in the field”, in the context of a process of certifying a MSP, is data relating to the management and performance in providing a specific service in a field by the MSP.

An MSP's “architectural configuration data for providing its service in the field”, in the context of a process of certifying a MSP, are data relating to the computer architecture, including communications between computing entities, in providing a specific service in a field by the MSP.

An MSP's “qualification data for providing its service in the field”, in the context of a process of certifying a MSP, are data relating to the specialty knowledge, qualifications, and/or experience of the MSP to manage the providing of the service in the field.

An MSP's “financial data as to charges by the MSP for providing its service in the field”, in the context of a process of certifying a MSP, are data relating to a financial value of the service in the field provided by the MSP. Example financial data may include the MSP's revenue, average deal size, largest deal size, smallest deal size, and other financial data.

An MSP's “data characterizing cyber risk exposure of the MSP in offering its service in the field”, in the context of a process of certifying a MSP, are data relating to the exposure of the MSP in specific risk scenarios.

“Technical security testing” includes technical evaluation of systems and applications that are supported by the MSP, including by means such as penetration testing and vulnerability scanning.

Data concerning “customer support processes and satisfaction levels” of a selected MSP includes (a) evidence of the MSP's IT support availability (24×7×365), (b) evidence that all employees of the MSP are trained and certified to deliver IT support services in accordance with the MSP's policies and governance framework, (c) customer references and reviews of the MSP, and (d) financial statements of the MSP.

### OVERVIEW OF EMBODIMENTS

The present application expands on subject matter contained in provisional application Ser. No. 63/495,918, filed Apr. 13, 2023, which is attached hereto and incorporated herein by reference. The technical assessment described herein is intended to generate evidence of cyber-security performance of a computer system. In one context, the output of the assessment supports a quantification of the risks associated with a given service provider in providing its service in a given field. In various embodiments, example fields include (1) backup as a service, (2) disaster recovery as a service, (3) firewall as a service, (4) business email protection as a service, (5) managed endpoint security as a service, and (6) any other cybersecurity services.

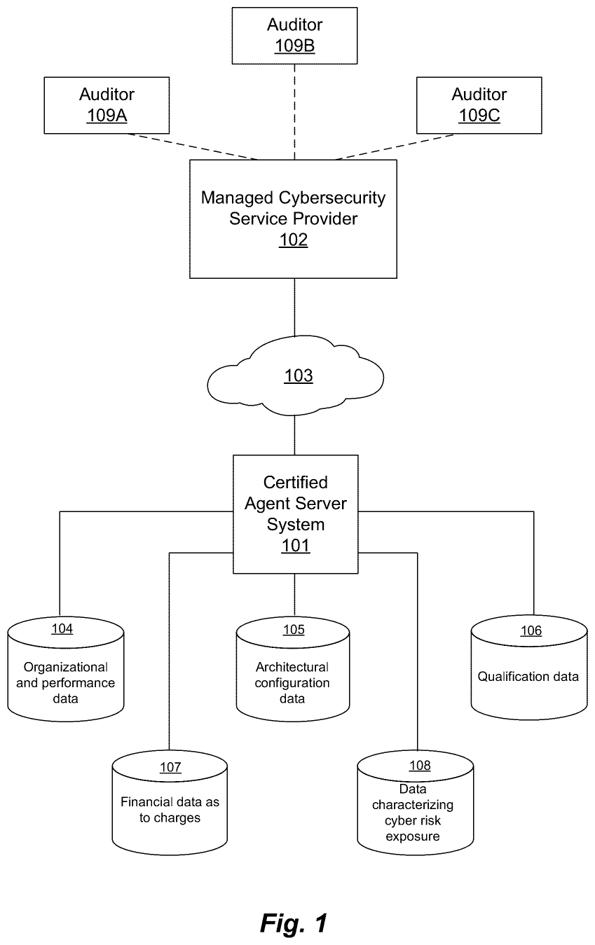

FIG. 1 is a block diagram of a computer system for evaluating an MSP for certification in providing a service in a field in accordance with an embodiment of the present invention. FIG. 1 shows a Certified Agent Server System (CASS) 101 configured to communicate with various data stores 104-108 storing data relevant to the certification of the MSP for providing a service in a given field. The stored data includes organizational and performance data 104, system architecture configuration data 105, qualification data 106, financial data as to charges 107, and data characterizing cyber risk exposure 108. The CASS 101 is further configured to communicate with the MSP 102 over a network, such that the MSP 102 may provide the evidence required for evaluation for certification. The MSP 102 may be configured to communicate with one or more third party auditors 109A, 109B, 109C, from which some of the evidence may be obtained.

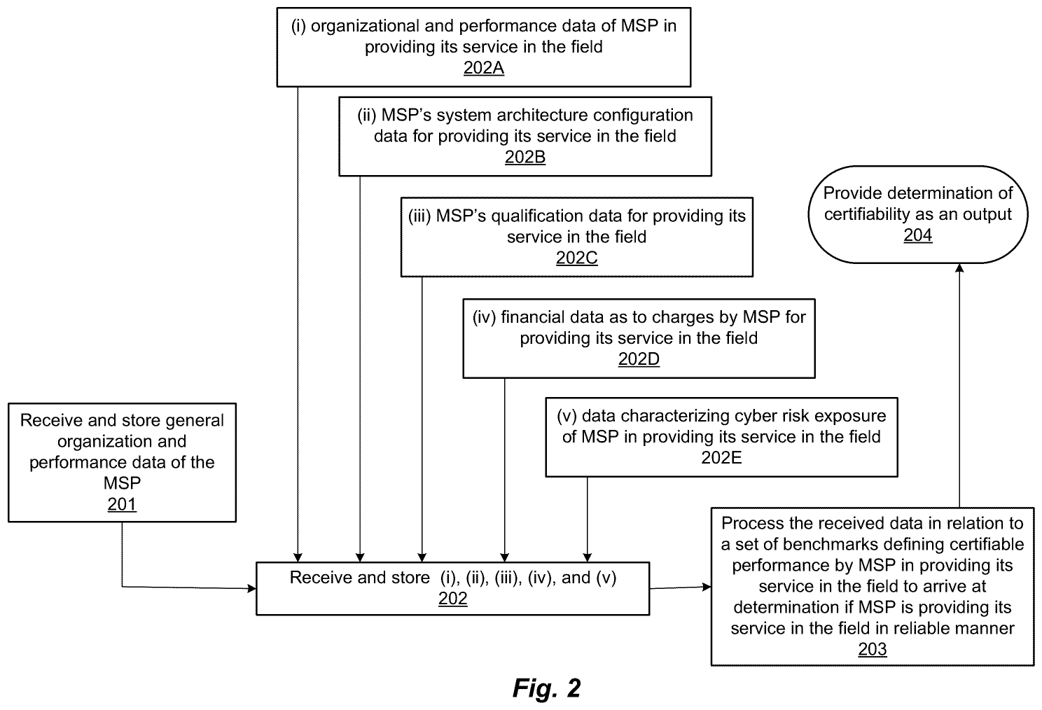

FIG. 2 is a block diagram illustrating a method for providing a technical assessment for certification an MSP 102 in providing a service in a field, implemented with computer processes carried out by the CASS 101, with the CASS 101 configured to be in network communication with the MSP 102 and with access to the data stores 104-108. In process 201, the CASS 101 receives and stores general organizational and performance data of the MPS 102, such data being obtained from the MSP 102 and a set of auditors, 109A-109C. In process 202, the CASS 101 receives and stores five categories of data: (i) organizational and performance data of the MSP 102 in providing its service in the field 202A, (ii) the MSP's system architecture configuration data for providing its service in the field 202B, (iii) the MSP's qualification data for providing its service in the field 202C, (iv) financial data as to charges by the MSP 102 for providing its service in the field 202D, and (v) data characterizing cyber risk exposure of the MSP 102 in providing its service in the field 202E. In a third process 203, the CASS 101 processes the received data in relation to a set of benchmarks defining technical performance by the MSP 102 in providing its service in the field to arrive at a determination if the MSP 102 is providing its service in the field in a reliable manner. In a fourth process 204, the CASS 101 provides the determination of certifiability as an output.

### Initial Certification of the MSP.

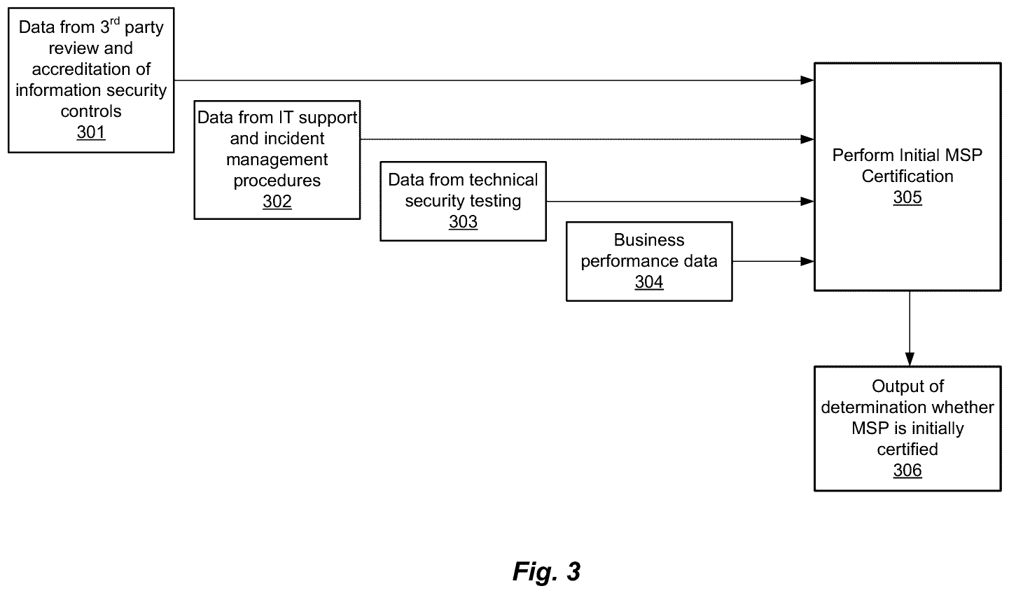

The certification process begins with an initial certification of the MSP 102 pertaining to its general organization and performance. As illustrated in the logical data flow illustrated in FIG. 3, various general organizational and performance data of the MSP 102 are used to perform this initial certification. Such data may include data from third party review and accreditation of information security controls 301, data from IT support and incident management procedures 302, data from technical security testing 303, and general business performance data 304.

MSPs are required to have at least one primary accreditation that is issued by a qualified third-party auditor 109A-109C based on criteria set by an industry-recognized standards body (ex. AICPA, ISO, etc.). In evaluating security and governance practices data, there are received external audit reports (provided annually) for evidence of the certification and the suitability/effectiveness of cybersecurity controls across a number of areas. The MSP is also invited to submit a secondary audit report, designed to evidence compliance with certain standards/requirements unique to particular jurisdictions or industries (ex. Cyber Essentials+ in the UK). The rationale for obtaining and using these data is that in addition to the valuable evidence collected and reported on as part of these recurring audits, the existence of a recurring third-party audit in itself offers an indication as to the level of sophistication/quality of the MSP (and its customer base, which is often the driving factor for MSPs to be subjected to an audit).

Furthermore, the CASS 101 assesses MSPs' customer support processes and satisfaction levels. The CASS 101 searches for evidence of the IT support availability (24×7×365) and that all employees are trained and certified to deliver IT support services in accordance with the company's policies/governance framework. This portion of the certification also entails reviewing customer references, reviews, as well as financial performance of the MSP 102. This section of the certification is designed to evaluate a MSPs ability to deliver services on a consistent basis, in a manner that satisfies obligations to/expectations from customers.

Additional evidence is received as to technical security testing conducted by the MSP or by a third party. These data can relate to network penetration testing, vulnerability scanning, or other technical evaluations of systems and applications supported by the MSP. This approach has benefits beyond being a best practice from a cyber-hygiene perspective, because regular testing is indicative of the MSP's ability to produce technical information that will be relevant to risk carriers looking to monitor current data across a broad portfolio of customers.

Finally, evidence of business performance, such as annual revenue, customer profiles, and average deal size is received to access the business performance of the MSP 102 in delivering its services.

The received evidence is processed to perform the initial certification of the MSP 305, the output of which is a determination of whether the MSP 102 is initially certified 306. This initial certification acts as a “gateway” certification, where the MSP 102 must be initially certified before proceeding with the certification of the MSP in providing the service in a specific field.

### Certification of MSP in Providing a Service in a Field

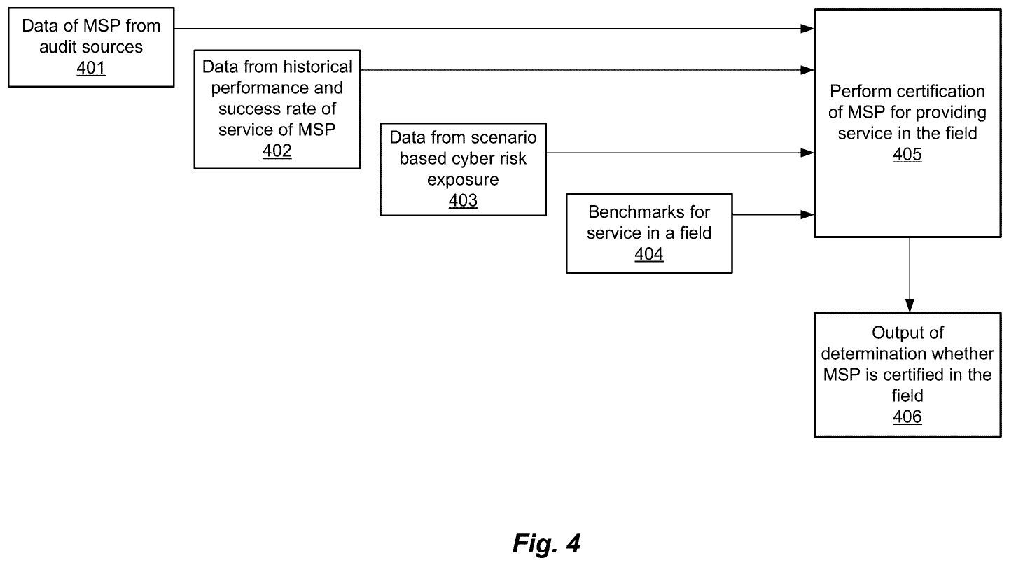

As illustrated in the logical data flow illustrated in FIG. 4, after the MSP is initially certified, various data sources provide evidence used to determine whether the MSP 102 meets the requirements for certification in providing a service in a field. The MSP 102 may apply to be certified in a number of fields, with each field being certified separately by the CASS 101. Such evidence may include data from audit sources 401, data from the MSP's historical performance and success rate of service 402, and data from scenario based cyber risk exposure 403. This data is evaluated against a set of benchmarks for the service in a given field 404. The benchmarks include the minimum requirements that apply to each service, with which all certified MSPs must comply. Each requirement is designed to improve the resiliency of a particular service against certain risk scenarios. For example, a good disaster recovery service should utilize different underlying infrastructure to minimize dependencies on a single cloud provider. The certification work may include an audit of the people skills and experience in the managing of the service, the MSP's own security and catastrophe/disaster plan (“cat plan”), and the verification of correct implementation for the end customer. The “cat plan” may include how an MSP prepares for scenarios where the entire network of the MSP becomes compromised or where multiple customers become compromised at the same time. The “cat plan” may further include the procedures and resources of the MSP that are in place to stop the spread of the effects of the compromise and address the incident (e.g., when the MSP becomes overwhelmed with incident response needs).

The evidence from the data sources 401-404 are processed to perform the certification of the MSP 102 for providing the service in the field 405, the output of which is a determination of whether the MSP 102 is certified in the field 406. For each service, data from the data sources 401-403 include: technology stack and architecture used to deliver the service (vendors, systems, and how they interact); service agreements, include service level agreements (SLAs), pertaining to the service; certifications, accreditations, and attestations that would provide evidence of third-party validation of the technical competency of the MSP and its employees; a numerical count of instances wherein the service has been deployed within the MSP customer base; system and device configurations used in providing the service; technical security testing results from providing the service; service design and historical performance and exposure to specific risk scenarios, including systemic risk; and probabilities of failure of the service to perform in the event of a disaster affecting an environment.

Finally, in various embodiments, each eligible service is evaluated against specific scenarios (“accumulated risk scenarios”) that are associated with MSPs), with the objective of understanding the tailored controls and processes implemented by each organization to mitigate risk associated with systemic cyber events, and to increase resilience in confronting such events.

Example fields of service include: (1) Disaster-Recovery-as-a-Service (DRaaS); (2) Backup-as-a-Service (BaaS); and (3) Firewall-as-a-Service (FWaaS); (4) Business-Email-Protection-as-a-Service (BEPaaS); and (5) Managed-End-Security-as-a-Service (MESaaS). Benchmarks 404 specific to each service are used to perform the certification of the MSP 102 in providing the service in the corresponding field.

The DRaaS may be defined as the replication of computer systems, applications, and data to a third-party cloud computing environment for the purpose of mitigating disruption caused by a catastrophic event affecting the primary computing environment. The design, installation/configuration, and ongoing maintenance of the replicated environment are fully managed by an outsourced party with specialty knowledge/qualifications/experience to operate the technology. An example for DRaaS may include: replicated environment secured with equivalent (or better) controls to primary environment; replicated environment utilizes different underlying infrastructure that is physically and logically segmented from the production environment; replicated environment is logically segmented by tenant; and recover tests of the replicated environment are conducted at least annually.

The BaaS may be defined as the replication of files and data from computer systems and cloud platforms to a third-party storage location in a manner that facilitates the restoration of a host whose files and data have been lost, corrupted, or otherwise made unavailable for use. The design, installation, configuration, and ongoing maintenance of the replicated environment are fully managed by an outsourced party with specialty knowledge/qualifications/experience to operate the technology. An example for BaaS may include: maintain a minimum of two geographically and logically segmented instances of recovery data, with at least one backup destination being immutable and isolated via offline, cloud, or off-site systems or services; backups being configured to perform automatically for all in-scope assets; all backup data being secured in transit and at rest with equivalent controls to the original data; unsuccessful backups triggering a notification and investigation process; and backups being tested at least quarterly for restorability.

The FWaaS may be defined as a cloud-based service that provides network security features such as packet filtering, network monitoring, content inspection, and secure communications which enables the control of authorized network traffic and blocking of malicious/unauthorized network communications. The design, installation/configuration, and ongoing maintenance of the hardware and software components of the service are fully managed by an outsourced party with specialty knowledge/qualifications/experience to operate the technology. An example for FWaaS may include: infrastructure running the latest stable release of software on vendor supported hardware; solution being configured for High Availability (HA); change management procedures approved by senior management and there exists an auditable log of change requests or implementations; system being configured to provide system & event logging, secure transmission of logs to a centralized host for collections, retention, analysis, and reporting; and the MSP providing 24×7 monitoring of all in-scope assets required to deliver the service and maintains incident response procedures that are regularly tested (at least annually).

BEPaaS may be defined as a platform service designed to provide a comprehensive solution for securing customer email accounts against take over. The design, installation/configuration, and ongoing maintenance of the hardware and software components of the service are fully managed by an outsourced party with specialty knowledge/qualifications/experience to operate the technology. An example for BEPaaS may include Identity & Access Management (IAM) services (including multi factor authentication for all accounts), email security features, implementation of Domain-based Message Authentication, Reporting and Conformance (DMARC), and security awareness training & testing. All accounts are monitored continuously for indicators of compromise (IOCs). The service is fully managed by a trained and certified engineering team at the MSP.

MESaaS may be defined as security service which protects the customer's endpoints from modern threats, including malware and malware-free attacks. The design, installation/configuration, and ongoing maintenance of the hardware and software components of the service are fully managed by an outsourced party with specialty knowledge/qualifications/experience to operate the technology. An example for MESaaS may include industry-leading endpoint detection and response (EDR) technology that is monitored continuously by a trained and experienced Security Operations Center (SOC). Each protected endpoint is backed up to an isolated environment, adding an additional layer of protection should the attacker manage to evade detection. The service is fully managed by a trained and certified engineering team at the MSP.

In processing the data, there can also be weighed subjective factors that cannot necessarily be measured directly or precisely, in which case qualified cybersecurity experts can be involved to validate data, fill gaps, and account for factors that are difficult to quantify (such as an organization's leadership and culture) that may impact the organization's risk profile.

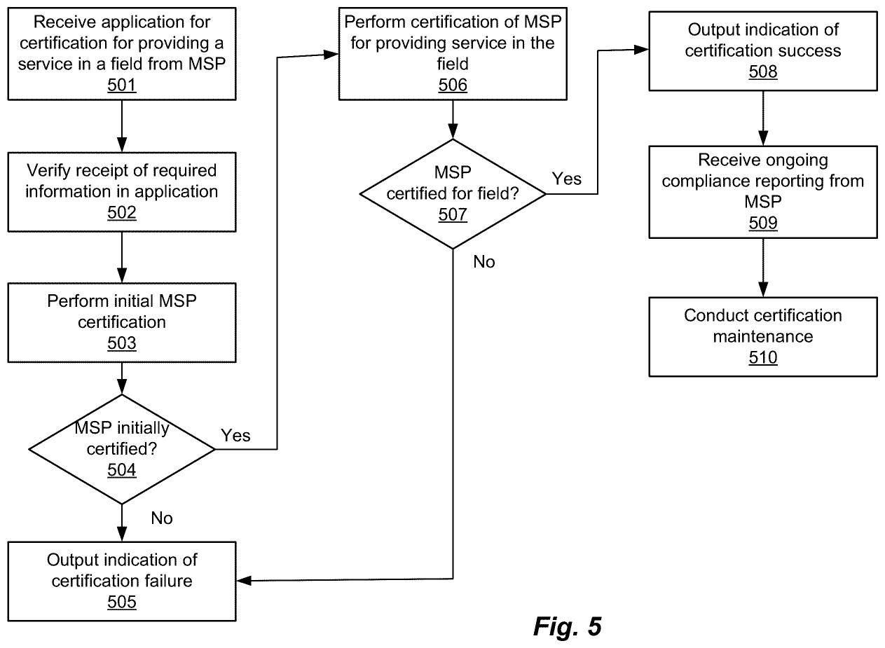

FIG. 5 illustrates a logical flow for the certification of an MSP in providing a service in a field. In process 501, the certification begins with the receipt, by the CASS 101, of an application for certification for providing a service in a field from the MSP 102. In process 502, the CASS 101 parses the data in the application to verify receipt of the required information. The required information may include general information of the MSP 102, the specific service(s) in the field(s) for certification, and company overview data (e.g., accreditations, business data, and technical security testing). In process 503, the CASS 101 performs the initial MSP certification, as described above with reference to FIG. 3. In processes 504 and 505, if the MSP 102 cannot be initially certified, then the CASS 101 outputs an indication of a certification failure. In processes 504 and 506, if the MSP 102 is initially certified, then the CASS 101 performs the certification of the MSP 102 for providing the service(s) in the field(s), as described above with reference to FIG. 4. In processes 507 and 505, if for any of the services, in which the MSP 102 cannot be certified in the field, the CASS 101 outputs an indication of the certification failure. In processes 507 and 508, for any of the services, in which the MSP 102 is certified in the field, the CASS 101 outputs an indication of certification success. In processes 509 and 510, after certifying the MSP 102 for providing service(s) in specific field(s), the CASS 101 receives ongoing compliance reportings from the MSP 102, with which the CASS 101 conducts the certification process again, as part of a certification maintenance process, to ensure continued compliance by the MSP 102.

The foregoing processes are directed to a technical assessment of cyber-security performance of a computer system, particularly the performance of a managed cybersecurity service provider that provides a managed information technology service of a specific type. A certification based on such a technical assessment supports a high degree of confidence in the managed cybersecurity service provider . . . . In one example implementation, the certification is specifically designed to provide an indication of the adequacy of the underlying cybersecurity service for underwriting and other purposes.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A computer-implemented method of providing a technical assessment for certification of a managed cybersecurity service provider (hereinafter “MSP”) in providing a cybersecurity service in a field, the method being implemented with computer processes carried out by a certification agent server system, the computer processes comprising:
receiving and storing, by the certification agent server system, general organizational and performance data of the MSP, such data being obtained from the MSP and a set of auditors;
receiving and storing, by the certification agent server system, (i) organizational and performance data of the MSP in providing its service in the field, (ii) the MSP's system architecture configuration data for providing its service in the field, (iii) the MSP's qualification data for providing its service in the field, (iv) financial data as to charges by the MSP for providing its service in the field, and (v) data characterizing cyber risk exposure of the MSP in providing its service in the field;
processing, by the certification agent server system, the received data in relation to a set of benchmarks defining technical performance by the MSP in providing its service in the field to arrive at a determination if the MSP is providing its service in the field in a reliable manner; and
causing, by the certification agent server system, the determination to be supplied as an output.

2. A computer-implemented method according to claim 1, wherein the field is selected from the group consisting of (i) backup as a service, (ii) disaster recovery as a service, (iii) firewall as a service, (iv) business email protection as a service, (v) managed endpoint security as a service, and (vi) any other similar service.

3. A computer-implemented method according to claim 1, wherein the computer processes include:
processing, by the certification agent server system, the received general organizational and performance data of the MSP to arrive at an initial determination of the MSP's ability to deliver services in an initial certifiable manner.

4. A computer-implemented method according to claim 1, wherein the general organizational and performance data, in a context of evaluating the MSP for certification, comprises data relating to a management and a performance in providing services that apply to the MSP as a whole.

5. A computer-implemented method according to claim 1, wherein the organizational and performance data, in a context of evaluating the MSP for certification, comprises data relating to a management and a performance in providing the service in the field by the MSP.

6. A computer-implemented method according to claim 1, wherein the system architecture configuration data for providing its service in the field, in a context of evaluating the MSP for certification, comprises data relating to a computer architecture, including communications between computing entities, in providing the service in the field by the MSP.

7. A computer-implemented method according to claim 1, wherein the qualification data for providing its service in the field, in a context of evaluating the MSP for certification, comprises data relating to a specialty knowledge, qualifications, or experience of the MSP to manage the providing of the service in the field.

8. A computer-implemented method according to claim 1, wherein the financial data as to the charges by the MSP for providing its service in the field, in a context of evaluating the MSP for certification, comprises data relating to a financial value of the service in the field provided by the MSP.

9. A computer-implemented method according to claim 1, wherein the data characterizing cyber risk exposure of the MSP in offering its service in the field, in a context of evaluating the MSP for certification, comprises data relating to an exposure of the MSP in specific risk scenarios.

10. A computer-implemented method according to claim 1, wherein a data source of the organizational data performance data of the MSP in providing its service in the field, the MSP's architectural configuration data for providing its service in the field, the MSP′ qualification data for providing its service in the field, the financial data as to the charges by the MSP for providing its service in the field, and the data characterizing the cyber risk exposure of the MSP in providing its service in the field, is selected from the group consisting of: data of the MSP from audit sources; data from historical performance and success rate of service of the MSP; and data from scenario based cyber risk exposure.

11. A computer-implemented method according to claim 1, wherein the set of benchmarks comprises minimum requirements that apply to the service in the field with which the MSP must comply.
